(19) United States
(12) Patent Application Publication
(10) Pub. No.: US 2022/0005139 A1
(43) Pub. Date: Jan. 6, 2022

(54) DIVERSIFIED AND CONNECTED FREIGHT ALLOCATION SYSTEM AND METHOD

(71) Applicant: CJ Logistics Corporation, Seoul (KR)

(72) Inventors: Tae Hyun KIM, Incheon (KR); Jong In CHAE, Gyeonggi-do (KR); Chang Yun CHUNG, Seoul (KR); Jun Hyuk CHOI, Seoul (KR); Seung Jin YOON, Gyeonggi-do (KR); Jae Won KIM, Seoul (KR); Ok Kyung LIM, Incheon (KR); Wan Sik KIM, Seoul (KR); Eun Jeong YOO, Seoul (KR)

(21) Appl. No.: 17/481,324

(22) Filed: Sep. 22, 2021

Related U.S. Application Data
(63) Continuation of application No. 17/137,449, filed on Dec. 30, 2020.

(30) Foreign Application Priority Data
Feb. 14, 2020 (KR) 10-2020-0018353

(51) Int. Cl. G06Q 50/28; G06F 7/08; G06Q 10/04; G06Q 10/06

(52) U.S. Cl. CPC G06Q 50/28; G06F 7/08; G06Q 30/018; G06Q 10/06315; G06Q 10/047

(57) ABSTRACT

The present disclosure relates to a diversified and connected freight allocation system and method, and more particularly, to a diversified and connected freight allocation system and method capable of reducing company's costs and improving resource utilization and efficiency.

In an aspect of the present disclosure, a diversified and connected freight allocation system is provided. The system includes: a data input unit; a reference information database containing reference information; and a diversified and connected freight allocation calculation unit determining diversified and connected freight allocations based on the information received from the data input unit and the reference information database.

### BACKGROUND OF THE INVENTION

### Field of the Invention

The present disclosure relates to a diversified and connected freight allocation system and method, and more particularly, to a diversified and connected freight allocation system and method capable of not only reducing company's costs and improving resource utilization and efficiency but also reducing a greenhouse gas emission amount in the road transport field from a social perspective.

### Description of the Related Art

In 2017, domestic greenhouse gas emissions by industrial sector are highest in energy industry, sequentially followed by manufacturing industry, construction industry, and transport industry. The transport sector accounts for 15.9% of domestic greenhouse gas emissions, with 98.4 million tCO₂eq, and the freight vehicle transport sector accounts for about 20% of the greenhouse gas emissions of the transport sector. The greenhouse gas emissions in the road transport sector continue to increase, and accordingly, efficient road transport is necessary to reduce greenhouse gas emissions.

As a way of efficient road freight transport, an operation of a freight vehicle may be minimized by minimizing a total freight transport distance, appropriately adjusting a share rate of each means for transport, and efficiently operating the vehicle. Among them, the efficiency of vehicle operation is determined by whether the vehicle is operated in an empty state, an average load amount, and a load capacity of the freight vehicle.

During common road freight transport, an empty vehicle incurs environmental pollution due to emissions of air pollutants and social costs due to traffic congestion. In terms of company operation, the empty-vehicle transport wastes company's transport resources, resulting in inefficient management activities. In 2017, an empty-vehicle operation rate of an average daily travel distance in the domestic freight vehicle transport industry was indicated as 39.5%. Thus, it is necessary to find a way to reduce the empty-vehicle operation.

Concerning freight transport, Korean Patent Laid-Open Publication No. 20170134754 discloses a method of trip determination for managing transit vehicle schedules. In order to manage transit vehicle schedules, this patent document suggests determining a current location and current heading of a transit vehicle by using a GPS module, communicating the current location and current heading with a computer, and matching trip schedules in a database in consideration of a current time and the location of the transit vehicle.

Also, Korean Patent Laid-Open Publication No. 2017-0000591 suggests providing a driver with a transportation order in the vicinity of the driver's current position based on the received transportation orders and the current positions of freight vehicles, and providing consecutive transportation orders by extracting a link transportation order that may be transported in association with the current transportation order and providing the extracted link transportation order to a transporter's terminal.

In addition, Korean Patent Laid-Open Publication No. 2016-0119633 suggests a linked freight transport management system operating in communication with transportation company, shipper and manager clients over a network to establish the most efficient routes for linked freight transport in terms of operating costs and social costs of each freight transport means, and a management method, a system, a computer program, and a recording medium for management thereof.

However, the patent documents as described above are difficult to practically apply in the transport field where a transport distance and an empty-vehicle distance are relatively long, because realistic restriction conditions that should be considered in freight transport for freight allocation are not considered at all. They only consider simple round-trip transport, while not considering diversified freight allocations or connected freight allocations that are connected to each other between a plurality of loading and unloading points. Therefore, there is a need to improve resource efficiency and maximize a reduction in cost in the freight transport by using diversified and connected freight allocations for allocating temporally linked orders to one transport vehicle such that the vehicle may handle two or more one-way orders within an empty-vehicle distance allowed by a user in consideration of loading/unloading points and times of the orders.

### SUMMARY OF THE INVENTION

The present disclosure is an invention conceived based on the above-described problems, and an object of the present disclosure is to provide a diversified and connected freight allocation system and method capable of reducing costs and improving resource efficiency in freight transport.

In order to solve the above-described problem, according to an aspect of the present disclosure, a diversified and connected freight allocation system is provided. The system includes: a data input unit; a reference information database containing reference information; and a diversified and connected freight allocation calculation unit determining diversified and connected freight allocations based on the information received from the data input unit and the reference information database. The data input unit is configured to receive order information and restriction conditions from a user and transmit the received order information and restriction conditions to the diversified and connected freight allocation calculation unit, the reference information database may be configured to transmit the reference information, including destination information, vehicle information, distance information, and freight charge information, to the diversified and connected freight allocation calculation unit, and the diversified and connected freight allocation calculation unit is configured to perform the diversified and connected freight allocations optimized based on the received order information, restriction conditions, and reference information.

In above-described aspect, the diversified and connected freight allocation calculation unit may include: a diversified freight allocation combination unit generating daily combinable diversified freight allocation combinations for orders on an identical date based on the received order information, restriction conditions, and reference information; a connected freight allocation combination unit generating connected freight allocation combinations combinable within a plan period based on the diversified freight allocation combinations generated by the diversified freight allocation combination unit; and a connected freight allocation computation unit maximizing the number of connection routes with respect to the connected freight allocation combinations generated by the connected freight allocation combination unit.

Further, in above-described aspect, the diversified freight allocation combination may be generated for the orders on the identical date in consideration of an empty-vehicle distance and an order handling sequence. When generating the diversified freight allocation combination, the diversified freight allocation combination unit may receive type of diversified freight allocations including short-distance allocations, long-distance allocations, and short-distance and long-distance allocations, so that the combination of orders is generated, for the orders belonging to the diversified freight allocation type, by a number equal to or less than a maximum number of rotations obtained from user input information.

Further, in above-described aspect, the connected freight allocation combination unit may generate possible connected freight allocation combination using the diversified freight allocation combinations generated by the diversified freight allocation combination unit and a maximum plan period among the user input information as input values. The connected freight allocation combination may be generated by combining the daily diversified freight allocation combinations for as many days as between at least two days and no greater than the maximum plan period to satisfy an inter-day empty-vehicle transport distance or coverage area and an order handling sequence.

Further, in above-described aspect, the connected freight allocation computation unit may be configured to: list all order IDs belonging to the connected freight allocation combinations that are possible for inter-day connection; count the number of times each of the order IDs is included in all of the connected freight allocation combinations and allocate as a score for each of the order IDs; set a sum of the scores allocated to the respective order IDs in each of the connected freight allocation combinations as a score for the respective connected freight allocation combination; and sort the respective sums of the scores for the connected freight allocation combinations in ascending order and employ higher-ranked combinations of orders having no order IDs overlapping as final connected freight allocation combination results.

In another aspect of the present disclosure, a diversified and connected freight allocation method is provided. The method includes: providing a diversified and connected freight allocation calculation unit; inputting order information, restriction conditions, and reference information to the diversified and connected freight allocation calculation unit; generating daily combinable diversified freight allocation combinations based on the input order information, restriction conditions, and reference information; generating connected freight allocation combinations combinable within a plan period based on the generated diversified freight allocation combinations; and optimizing connected freight allocations by maximizing the number of connection routes with respect to the generated connected freight allocation combinations.

The diversified freight allocation combination may be generated for the orders on the identical date in consideration of an empty-vehicle distance and an order handling sequence. When generating the diversified freight allocation combination, the diversified freight allocation combination unit may receive type of diversified freight allocations including short-distance allocations, long-distance allocations, and short-distance and long-distance allocations, so that the combination of orders is generated, for the orders belonging to the diversified freight allocation type, by a number equal to or less than a maximum number of rotations obtained from user input information.

The connected freight allocation combination may be generated using the diversified freight allocation combinations generated by the diversified freight allocation combination unit and a maximum plan period among the user input information as input values. The connected freight allocation combination may be generated by combining the daily diversified freight allocation combinations for as many days as between at least two days and no greater than the maximum plan period to satisfy an inter-day empty-vehicle transport distance or coverage area and an order handling sequence.

In addition, the optimizing of the connected freight allocations may include: listing all order IDs belonging to the connected freight allocation combinations that are possible for inter-day connection; counting the number of times each of the order IDs is included in all of the connected freight allocation combinations to be allocated as a score for each of the order IDs; setting a sum of the scores allocated to the respective order IDs in each of the connected freight allocation combinations as a score for the respective connected freight allocation combination; and sorting the respective sums of the scores for the connected freight allocation combinations in ascending order and employing higher-ranked combinations of orders having no order IDs overlapping as final connected freight allocation combination results.

### BRIEF DESCRIPTION OF THE DRAWINGS

FIG. 1 is a diagram for explaining a relationship between a diversified freight allocation and a connected freight allocation;

FIG. 2 is a diagram for explaining types of orders and types of freight allocations;

FIG. 3 is a flowchart illustrating a diversified and connected freight allocation method according to the present disclosure;

FIG. 4 is a diagram illustrating an example of a process of optimizing connected freight allocation combinations in the diversified and connected freight allocation method according to the present disclosure; and

FIG. 5 is a block diagram schematically illustrating a diversified and connected freight allocation system according to the present disclosure.

### DETAILED DESCRIPTION OF THE PREFERRED EMBODIMENTS

Advantages and features of the present disclosure and implementation methods thereof will become apparent through the embodiments that will be described in detail with reference to the accompanying drawings. However, it should be understood that the present disclosure is not limited to the embodiments set forth herein and maybe implemented in various different forms.

In the specification, the embodiments are provided so that the present disclosure will be thorough and complete, and will fully convey the scope of the present disclosure to those skilled in the art. In addition, the present disclosure is defined only by the appended claims. Accordingly, in some embodiments, well-known components, well-known operations, and well-known techniques will not be described in detail to avoid ambiguous interpretation of the present disclosure.

Throughout the specification, like reference numerals refer to like elements. In addition, the terms used (mentioned) in the specification are only for explaining the embodiments and does not limit the present disclosure. The singular forms may include plural forms unless the context clearly indicates otherwise. It will be further understood that the terms “comprise” and “include”, when used herein, do not preclude the presence or addition of one or more other elements and operations.

Unless otherwise defined, all terms (including technical and scientific terms) used herein have the same meaning as commonly understood by those skilled in the art. It will be further understood that terms defined in commonly used dictionaries should not be interpreted in an idealized or overly formal sense unless expressly defined herein.

Hereinafter, a diversified and connected freight allocation system and method according to embodiments of the present disclosure will be described with reference to the accompanying drawings.

A diversified freight allocation refers to allocating temporally linked orders to one transport vehicle such that the vehicle may handle two or more one-way orders within an empty-vehicle distance allowed by a user in consideration of loading/unloading points and times of the orders. In the diversified freight allocation, only one of the orders may be handled during one-time transport (mixed loading is not possible).

In addition, a connected freight allocation refers to an allocation to the vehicle by connecting diversified freight allocation results for a plan period (between at least 2 days and at most 7 days) set by the user.

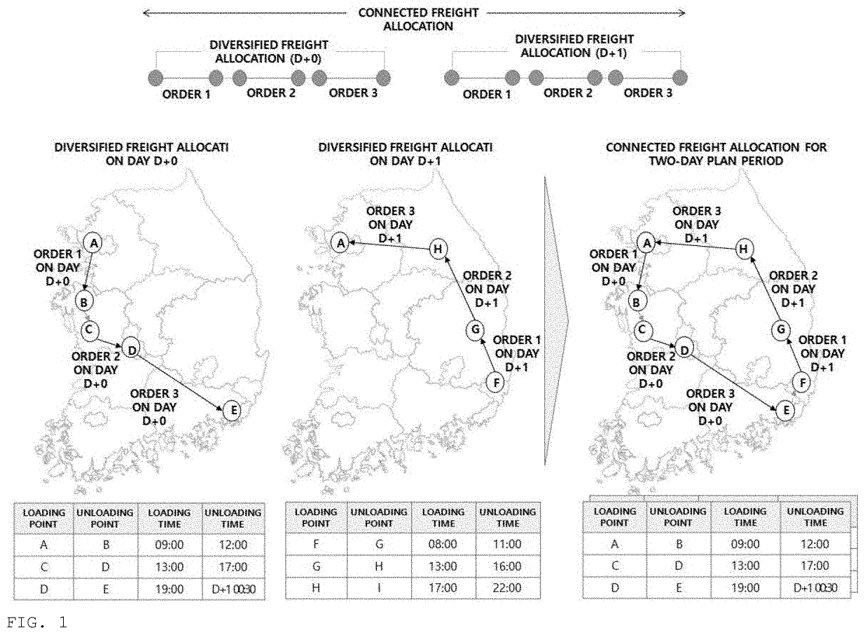

FIG. 1 is a diagram for explaining the diversified freight allocation and the connected freight allocation as described above. As illustrated in (a) to (c) of FIG. 1, one connected freight allocation includes a plurality of diversified freight allocations.

For example, it may be seen that the connected freight allocation illustrated in FIG. 1 has a plan period of two days (dayD+0 and dayD+1), and one diversified freight allocation is set for each day of the plan period. Specifically, it may be seen that the connected freight allocation includes two diversified freight allocations, with a diversified freight allocation on day D (day D+0) being exemplified to have three orders from loading point A to unloading point E and a diversified freight allocation on the day after day D (day D+1) being exemplified to have three orders from loading point F to unloading point A.

Therefore, connection routes may be defined as a collection of sections for the orders to be executed by one vehicle within the plan period as a connected freight allocation result.

Regarding the design of the diversified freight allocation or the connected freight allocation, it is necessary to allocate as many orders as possible that can be handled by the vehicle within available operation hours in order to increase efficiency in operating the transport vehicle. Accordingly, there is a need for a diversified and connected freight allocation algorithm or method to establish a plan for allocating multiple orders to one vehicle in consideration of loading/unloading points of the orders and order handling times.

Thus, a system providing the diversified and connected freight allocation algorithm needs to receive transport orders, location information, and user setting information and classify the orders into various types of freight allocations to suggest connection routes to the user.

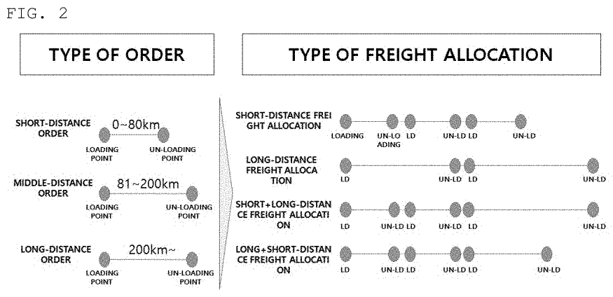

Next, types of diversified freight allocations will be described below with reference to FIG. 2. FIG. 2 is a diagram for explaining types of orders and types of freight allocations. The types of orders are classified based on a travel distance from a loading point to an unloading point for the order.

Specifically, the following reference values are used to classify the orders by type in the diversified and connected freight allocation algorithm: 0 to less than 80 km one way for short-distance orders; 80 km to less than 200 km one way for middle-distance orders; and 200 km or more one way for long-distance orders. However, it is obvious to those skilled in the art that the reference values may be changed within an appropriate range.

Based on the types of orders, the freight allocations are classified into the following types: a short-distance freight allocation having a combination of short-distance orders only, a long-distance freight allocation having a combination of long-distance orders only, and a short+long(middle)-distance freight allocation having a combination of short-distance and middle/long-distance orders.

The diversified and connected freight allocation algorithm according to the present disclosure is constructed to receive the number of times of transports for each type of freight allocation and the number of connected days to configure diversified freight allocation combinations with the number of times of transports for each type of freight allocation being a maximum number of orders and to configure connected freight allocation combinations with the number of connected days being a maximum number of plan days.

At the time of configuring diversified and connected freight allocations, an empty-vehicle transport distance or a transport coverage area may be considered. The user inputs an empty-vehicle distance for a diversified freight allocation and an empty-vehicle distance for a connected freight allocation as user input information. When orders are connected for the diversified freight allocation, the diversified freight allocation is configured as a combination only when a distance between an unloading point for order 1 and a loading point for order 2 is within the input empty-vehicle distance for the diversified freight allocation or the unloading point for the order 1 and the loading point for the order 2 are in the same coverage area. In the case of the connected freight allocation, the connected freight allocation is configured as a combination of diversified freight allocations when a distance between an unloading point for the last order on the day D and a loading point for the first order on the day D+1 is within the input empty-vehicle distance for the connected freight allocation or the loading and unloading points are in the same coverage area.

In addition, as shown in Table 1, it is preferable that when a requested loading time and a requested unloading time are input as order information among the information input to the algorithm, in a case of connecting two orders, if a requested unloading time for the order 1 is later than a requested loading time for the order 2, the two orders are not connected.

TABLE 1

| Loading | Unloading | Loading | Unloading | Connectable |
|---|---|---|---|---|
| time for | time for | time for | time for | or |
| order 1 | order 1 | order 2 | order 2 | unconnectable |
| 09:00 | 16:00 | 17:00 | 22:00 | Connectable |
| 17:00 | 22:00 | 09:00 | 16:00 | Unconnectable |

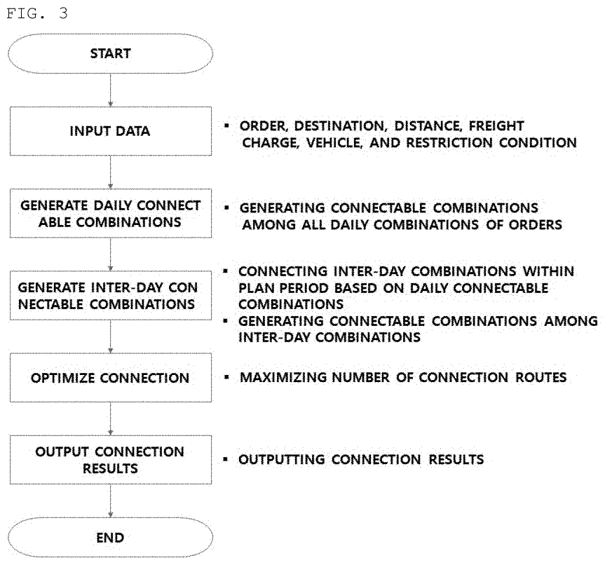

FIG. 3 is a flowchart illustrating a flow of the diversified and connected freight allocation method according to the present disclosure. As illustrated in FIG. 3, the diversified and connected freight allocation method according to the present disclosure includes: inputting data, such as order, destination, distance, freight charge, vehicle, and restriction condition, to the diversified and connected freight allocation system; generating daily connectable data combinations by generating connectable combinations among all daily combinations of orders; generating inter-day connectable combinations by connecting the inter-day combinations within the plan period based on daily connectable data combinations and generating connectable combinations among the inter-day combinations; optimizing a connection by maximizing the number of connection routes; and outputting connection results.

In the inputting of the data, reference information is received from a reference information database, and user input information is received from the user. The reference information includes destination information, vehicle information, distance information, and freight charge information, and the above information is previously stored in the reference information database. The order information input by the user may include order ID, customer number, customer code, loading point name, unloading point name, order category, loading date, unloading date, item, quantity, vehicle type, and order-requested tonnage level. The restriction condition information may include maximum plan period, the number of daily rotations, minimum and maximum operation distances for each type of connection, daily and inter-day allowable empty-vehicle distances for each type of connection, and speed for each section of operation.

The data input information as described above is listed in Table 2 below.

TABLE 2

| Classifica- | Type of | |
|---|---|---|
| tion | information | Detailed data |
| Reference | Destination | Destination name, destination ID, |
| information | information | address, latitude/longitude, required |
| | | time for loading, required time for |
| | | unloading, available loading time, |
| | | available unloading time, city/province, |
| | | city/county/district, and coverage area |
| | Vehicle | Vehicle number, vehicle type, tonnage |
| | information | level, operation period, the number of |
| | | daily rotations |
| | Distance | Actual distance between destinations |
| | information | |
| | Freight | Tonnage-level freight charge between |
| | charge | destinations |
| | information | |
| User input | Order | Order ID, customer number, customer |
| information | information | code, loading point name, unloading |
| | | point name, order category, loading |
| | | date, unloading date, item, quantity, |
| | | vehicle type, and order-requested |
| | | tonnage level |
| | Restriction | Maximum plan period, the number of daily |
| | conditions | rotations, minimum and maximum operation |
| | | distances for each type of connection, |
| | | daily and inter-day allowable empty- |
| | | vehicle distances for each type of |
| | | connection, and speed for each section |
| | | of operation |

Regarding the loading/unloading point name among the order information, when a loading/unloading point name is input, a latitude/longitude, a required time for loading time/unloading, an available loading/unloading time, a coverage area, and a maximum entry-permitted tonnage level of a destination corresponding to a relevant destination name are determined with reference to the destination information table among the reference information data, and this is used as input information for the diversified freight allocation.

Regarding the vehicle type and the order-requested tonnage level among the order information, when matching an order and a vehicle, a vehicle type and a tonnage level are considered with reference to the vehicle information table among the reference information data to determine whether the order and the vehicle may be matched.

The actual distance table among the reference information tables is referred when calculating a travel distance for each rotation and an empty-vehicle distance for a diversified/connected freight allocation of an order, so that a travel time is calculated by applying a travel speed for each operation distance section in the restriction condition table according to the calculated travel distance.

After executing the diversified/connected freight allocation algorithm, a vehicle number for an order allocated to a vehicle is output with reference to the vehicle information table, and an order number, loading/unloading point names, and locations and coverage areas of loading/unloading points, and an order category for the order allocated to the vehicle number are output using the order information table. In addition, a loading point arrival time, a loading start time, a loading completion time, an unloading point arrival time, an unloading start time, and an unloading completion time calculated based on the actual distance and restriction condition tables are output.

Tables 3 and 4 below are tables showing details of the order information and the user input information as described above.

TABLE 3
Details of Order Information and
Destination Information

| | Specific | |
|---|---|---|
| | type of | |
| Classification | information | Details |
| Order | Order ID | ID of order placed |
| information | Customer | Customer number of corresponding order |
| | number | |
| | Customer | Customer code of corresponding order |
| | code | |
| | Loading | Loading point name of order placed |
| | point name | |
| | Unloading | Unloading point name of order placed |
| | point name | |
| | Order | Type of order placed (same day arrival, |
| | category | next day arrival, closing) |
| | | Same day arrival: order for which |
| | | loading and unloading are performed |
| | | within working hours on the same day |
| | | Next day arrival: order for which |
| | | loading is performed on the same day |
| | | and unloading is performed on the next |
| | | day |
| | | Closing: order for which loading is |
| | | performed after working hours on the |
| | | same day and unloading is performed |
| | | after working hours on the same day and |
| | | before dawn on the next day |
| | Loading | Loading date of order placed |
| | date | |
| | Unloading | Unloading date of order placed |
| | date | |
| | Item | Item of freight to be transported |
| | Quantity | Quantity of freight to be transported |
| | Vehicle | Vehicle type capable of corresponding |
| | type | relevant order |
| | Order- | Tonnage of vehicle capable of handling |
| | requested | corresponding order |
| | tonnage | |
| | level | |
| Destination | Destination | Name of destination of |
| information | name | loading/unloading point |
| (specific | Destination | ID of destination of loading/unloading |
| information | ID | point |
| associated | Address | Address of loading/unloading point |
| with | Latitude/ | Latitude/longitude of loading/unloading |
| loading/unload | longitude | point |
| ing point | Required | Time (minutes) required for loading |
| among order | time for | freight at loading point |
| information) | loading | |
| | Required | Time (minutes) required for unloading |
| | time for | freight at unloading point |
| | unloading | |
| | Available | Time available for loading freight at |
| | loading | loading point (start time to close |
| | time | time) |
| | Available | Time available for unloading freight at |
| | unloading | unloading point (start time to close |
| | time | time) |
| | City/province | City or province where |
| | | loading/unloading point is located |
| | City/county/ | City/county/district where |
| | district | loading/unloading point is located |
| | Coverage | Coverage area where loading/unloading |
| | area | point is located |

TABLE 4
Details of Distance Information, Freight
Charge Information, Vehicle Information, and Restriction
Conditions

| | Specific | |
|---|---|---|
| | type of | |
| Classification | information | Details |
| Distance | Actual | Distance between destination |
| information | distance | |
| | between | |
| | loading and | |
| | unloading | |
| | points | |
| Freight charge | Freight | Freight charge between destinations for |
| information | charge | each vehicle type/tonnage level |
| | between | |
| | loading and | |
| | unloading | |
| | points | |
| Vehicle | Vehicle | Vehicle number |
| information | number | |
| | Vehicle | Type of vehicle |
| | type | |
| | Tonnage | Vehicle tonnage level |
| | level | |
| | Operation | Plan period of corresponding vehicle |
| | period | (This may selected between at least |
| | | 2 days to at most 7 days according to |
| | | driver's preference. A different plan |
| | | period may be given for each vehicle |
| | | within the maximum plan period among |
| | | restriction conditions.) |
| | Number of | Maximum number of orders that |
| | daily | corresponding vehicle may handle for one |
| | rotations | day |
| Restriction | Maximum | (For all vehicles) Maximum number of |
| conditions | plan period | days available for connected freight |
| | | allocation |
| | Number of | (For all vehicles) Maximum number of |
| | daily | rotations within one day available for |
| | rotations | diversified freight allocation |
| | Minimum | Minimum operation distance of each |
| | operation | vehicle for each type of connection |
| | distance | (short distance, long distance, short |
| | for each | distance + middle distance, and short |
| | type of | distance + long distance) |
| | connection | |
| | Maximum | Maximum operation distance of each |
| | operation | vehicle for each type of connection |
| | distance | |
| | for each | |
| | type of | |
| | connection | |
| | Allowable | Allowable empty-vehicle distance between |
| | daily | unloading point for previous order and |
| | empty- | loading point for current order at the |
| | vehicle | time of connecting orders for period of |
| | distance | one day for each type of connection |
| | for each | connection |
| | type of | |
| | Allowable | Allowable empty-vehicle distance between |
| | inter-day | unloading point for previous order and |
| | empty- | loading point for current order at the |
| | vehicle | time of connecting orders for period of |
| | distance | multiple days for each type of |
| | for each | connection |
| | type of | |
| | connection | |
| | Speed for | Speed for each distance section at which |
| | each | vehicle may travel |
| | operation | |
| | section | |

The generating of the daily connectable combinations (diversified freight allocations) refers to selecting diversified freight allocation combinations, and possible diversified freight allocation combinations are each generated, among combinations of orders on an identical date, in consideration of the empty-vehicle distance and the order handling sequence.

At the time of generating the combinations of orders, the type of diversified freight allocation (short-distance freight allocation, long-distance freight allocation, or short/long-distance freight allocation) is received, and combinations of orders belonging to the type of diversified freight allocation are generated, with the number of combined orders being at least two and no greater than a maximum number of rotations (received from the user input information). In addition, among the generated combinations of orders, combinations satisfying the empty-vehicle transport distance or coverage area and the order handling sequence are stored as the possible diversified freight allocation combinations.

The generating of the inter-day connectable combinations refers to selecting connected freight allocation combinations in which inter-day combinations within the plan period are connected based on the daily connectable combinations. In the generating of the connected freight allocation combinations, possible connected freight allocation combinations are generated using the possible diversified freight allocation combinations and the maximum plan period among the user input information as input values.

The possible connected freight allocation combinations are generated by combining as many daily combinations as the number of days between at least two days and no greater than the maximum plan period (e.g. seven days) to generate a connected freight allocation combination that satisfies an inter-day empty-vehicle transport distance or coverage area and an order handling sequence.

In the optimizing of the connection by maximizing the number of connection routes, all order IDs belonging to the combinations possible for inter-day connection are listed, the number of times each of the order IDs is included in all of the combinations is counted to be set as a score for each of the IDs, a sum of the scores of the respective IDs in each of the combinations is set as a score for the respective combination, and then the respective sums of the scores for the combinations are sorted in ascending order and higher-ranked combinations of orders having no order IDs overlapping are employed as final results.

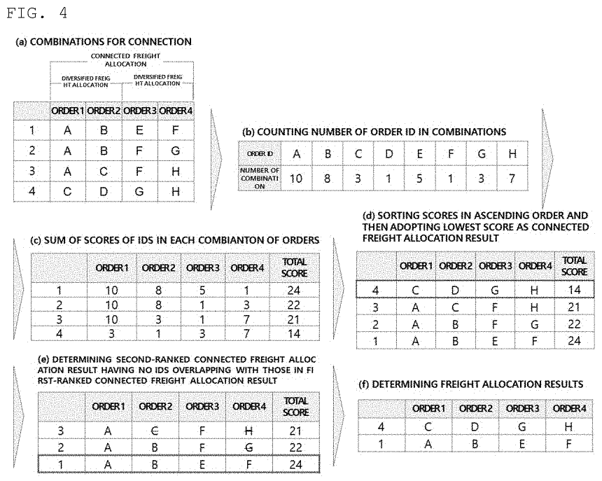

FIG. 4 is a diagram for explaining the connection optimizing process as described above. As illustrated in (a) of FIG. 4, a list of connected freight allocation combinations that are possible for inter-day connection is generated through the previous step of generating inter-day connectable combinations.

For easier understanding and convenience of explanation, in (a) of FIG. 4, it is assumed that a connected freight allocation includes a combination of two diversified freight allocations, each of the diversified freight allocations including two order IDs (A to H). In addition, the order ID represents a route constituting the diversified freight allocation.

Next, for optimal diversified and connected freight allocations, the number of order IDs which constitute the list of the connectable connected freight allocation combinations is counted. This is to calculate respective frequencies of appearance of routes which constitute the list of connected freight allocations. It may be seen from (b) of FIG. 4 that, in the list of connected freight allocations of (a) of FIG. 4, a route for ID A appears 10 times with the highest frequency of appearance and routes for IDs D and F appear only once with the lowest frequency of appearance.

Subsequently, as illustrated in (c) of FIG. 4, respective scores of IDs in each of the combinations of orders are added up. For example, as illustrated in (a) of FIG. 4, combination 1 has a connected freight allocation of A-B-E-F. If frequency scores of appearance are assigned to the respective route IDs based on (b) of FIG. 4, a total score is calculated as 24 points. In the same way, combination 2 has a connected freight allocation of A-B-E-F with a total score of 22 points, combination 3 has a connected freight allocation of A-C-F-H with a total score of 21 points, and combination 4 has a connected freight allocation of C-D-G-H with a total score of 14 points.

As illustrated in (c) of FIG. 4, once the total scores for the respective connected freight allocations are calculated, the calculated total scores are sorted in ascending order, and a connected freight allocation having the lowest score is adopted as a connected freight allocation result. In this regard, referring to (d) of FIG. 4, since the combination 4 has the lowest connected freight allocation score as 14 points, it is preferentially assigned for the connected freight allocation.

As illustrated in (e) of FIG. 4, a connected freight allocation having no route IDs overlapping with those in the selected connected freight allocation result is subsequently selected. For example, as illustrated in (e) of FIG. 4E, the combination 3 and the combination 2 are excluded from connected freight allocations because they include route IDs (C, H and G) overlapping with those in the combination 4. Only the combination 1 has route IDs that do not overlap with those in the combination 4, and thus is selected for connected freight allocation.

Through this process, as illustrated in (f) of FIG. 4, only two connected freight allocations are selected and output as connected freight allocation results. The connected freight allocation results are output as a file containing an order ID, a loading point, an unloading point, a loading coverage area, an unloading coverage area, a loading point arrival time, loading start/completion times, an unloading point arrival time, and unloading start/completion times for each result of combination.

According to the diversified and connected freight allocation method as described above, it is possible to maximize the number of orders that each vehicle can transport within the allowable empty-vehicle operation range, thereby increasing efficiency in operating the vehicle, and it is possible to automatically derive connectable routes on the basis of the diversified (connected) freight allocation algorithm when order information is input, thereby enabling efficient work. Therefore, an empty-vehicle time may be reduced, and accordingly, greenhouse gas emissions from vehicles may be reduced and traffic congestion on roads may also be reduced.

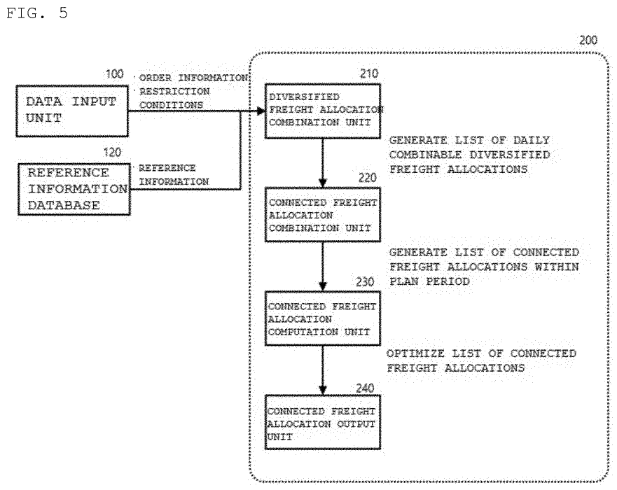

FIG. 5 is a diagram illustrating an example of the diversified and connected freight allocation system for performing the diversified and connected freight allocation method as described above. As illustrated in FIG. 5, the diversified and connected freight allocation system includes a data input unit 100 for a user to input data, a reference information database 120 storing reference information, and a diversified and connected freight allocation calculation unit 200.

The data input unit 100 is configured for the user to input order information. The input information may include order ID, customer number, customer code, loading point name, unloading point name, order category, loading date, unloading date, item, quantity, vehicle type, and order-requested tonnage level, and the restriction condition information may include maximum plan period, the number of daily rotations, minimum and maximum operation distances for each type of connection, daily and inter-day allowable empty-vehicle distances for each type of connection, and speed for each operation section.

The reference information database 120 includes destination information, vehicle information, distance information, and freight charge information, and these information are previously stored in the reference information database and input upon request from the calculation unit 200.

A diversified freight allocation combination unit 210, which generates a list of daily combinable diversified freight allocations, generates diversified freight allocation combinations capable of diversified freight allocations for combinations of orders on an identical date in consideration of the empty-vehicle distance and the order handling sequence.

At the time of generating the combinations of orders, the type of diversified freight allocation (short-distance freight allocation, long-distance freight allocation, or short/long-distance freight allocation) is received, and combinations of orders belonging to the type of diversified freight allocation are generated, with the number of combined orders being at least two and no greater than a maximum number of rotations (received from the user input information). In addition, among the generated combinations of orders, combinations satisfying the empty-vehicle transport distance or coverage area and the order handling sequence are stored as possible diversified freight allocation combinations.

A connected freight allocation combination unit 220 functions to connect inter-day combinations within the plan period based on the possible diversified freight allocation combinations. In the generating of the connected freight allocation combinations, a list of connected freight allocations possible for connected freight allocation is generated using the possible diversified freight allocation combinations and the maximum plan period among the user input information as input values.

The possible connected freight allocation combinations are generated by combining as many daily combinations as the number of days between at least two days and no greater than the maximum plan period (e.g. seven days) to generate a connected freight combination that satisfy an inter-day empty-vehicle transport distance or coverage area and an order handling sequence.

A connected freight allocation computation unit 230, which performs optimizing a connection by maximizing the number of connection routes, lists all order IDs belonging to the combinations possible for inter-day connection, counts the number of times each of the order IDs is included in all of the combinations to be set as a score for each of the IDs, sets a sum of the scores of the IDs in each of the combinations as a score for the respective combination, and then sorts the respective sums of the scores for the combinations in ascending order based on the total score and employs higher-ranked combinations of orders having no order IDs overlapping as final results.

A connected freight allocation output unit 240 outputs optimized connected freight allocation results. The connected freight allocation results are output as a file containing an order ID, a loading point, an unloading point, a loading coverage area, an unloading coverage area, a loading point arrival time, loading start/completion times, an unloading point arrival time, and unloading start/completion times for each result of combination.

The system described above may be implemented with hardware components, software components, and/or a combination of hardware components and software components. For example, the devices and components described in the embodiments may be implemented by using one or more general-purpose computers or special-purpose computers, such as processors, controllers, arithmetic logic units (ALUs), digital signal processors, microcomputers, field programmable gate arrays (FPGAs), programmable logic units (PLUs), microprocessors, or any other devices capable of executing and responding to instructions. A processing device may run an operating system (OS) and one or more software applications that operate under the OS. Also, the processing device may access, store, manipulate, process, and generate data while executing the software applications. For convenience of understanding, the singular term “processing device” may be used in the description, but those skilled in the art will appreciate that the processing device may include multiple processing elements and/or multiple types of processing elements. For example, the processing device may include a plurality of processors or, alternatively, one processor and one controller. In addition, different processing configurations are possible, such as parallel processors or multi-core processors.

The algorithm or software may include a computer program, a code, an instruction, or one or more combinations thereof, for independently or collectively instructing or configuring the processing device to operate as desired. Software and/or data may be embodied in any type of machine, component, physical or virtual equipment, or computer storage medium or device in order to provide instructions or data to the processing device or to be interpreted by the processing device. The software may also be distributed over network-coupled computer systems so that the software is stored and executed in a distributed fashion. The software and data may be stored in one or more computer-readable recording media.

In addition, the method and algorithm according to the embodiments may be implemented in the form of program instructions that may be executed through various computer means and may be recorded in computer-readable media. The computer-readable media may include program instructions, data files, data structures, and the like alone or in combination. The program instructions recorded in the media may be designed and configured specially for the embodiments or be known and available to those skilled in computer software. Examples of the computer-readable recording media include magnetic media such as hard disks, floppy disks, and magnetic tape; optical media such as compact disc read-only memories (CD ROM) disks and digital video discs (DVDs); magneto-optical media such as floptical disks; and hardware devices that are specially configured to store and perform program instructions, such as ROMs, random access memories (RAMs), and flash memories. Examples of the program instructions include both machine codes produced by a compiler and higher-level language codes executable by a computer using an interpreter or the like.

According to the present disclosure, temporally linked orders are allocated to one transport vehicle such that the vehicle may handle two or more one-way orders within an empty-vehicle distance allowed by a user in consideration of loading/unloading points and times of the orders, thereby reducing company's operating costs and improving resource utilization and efficiency. In addition, it is possible to minimize an empty-vehicle distance as compared to that in conventional one-way transport, thereby reducing greenhouse gas emission from the vehicle and also reducing road traffic congestion.

While a few embodiments have been described above with reference to the accompanying drawings, it will be apparent to those skilled in the art that various modifications and variations may be made from the foregoing descriptions. For example, adequate effects may be achieved even if the above-described techniques are carried out in a different order than described above, and/or the above-described elements, such as systems, structures, devices, or circuits, are combined or coupled in different forms and modes than as described above or be substituted or switched with other elements or equivalents.

Therefore, other implementations, other embodiments and equivalents to the claimed subject matter are construed as falling within the scope of the claims.

What is claimed is:

1. A diversified and connected freight allocation system, the system comprising:
a data input unit;
a reference information database containing reference information; and
a diversified and connected freight allocation calculation unit determining diversified and connected freight allocations based on the information received from the data input unit and the reference information database,
wherein the data input unit is configured to receive order information and restriction conditions from a user and transmit the received order information and restriction conditions to the diversified and connected freight allocation calculation unit,
the reference information database is configured to transmit the reference information including destination information, vehicle information, distance information, and freight charge information to the diversified and connected freight allocation calculation unit,
the diversified and connected freight allocation calculation unit is configured to perform the diversified and connected freight allocations to be optimized based on the received order information, restriction conditions, and reference information, and
wherein the diversified and connected freight allocation calculation unit includes:
a diversified freight allocation combination unit generating daily combinable diversified freight allocation combinations for orders on an identical date based on the received order information, restriction conditions, and reference information;
a connected freight allocation combination unit generating connected freight allocation combinations combinable within a plan period based on the diversified freight allocation combinations generated by the diversified freight allocation combination unit; and
a connected freight allocation computation unit maximizing the number of connection routes with respect to the connected freight allocation combinations generated by the connected freight allocation combination unit, and
wherein the diversified freight allocation combination is generated for the orders on the identical date in consideration of an empty-vehicle distance and an order handling sequence, and when generating the diversified freight allocation combination, the diversified freight allocation combination unit receives type of diversified freight allocations including short-distance allocations, long-distance allocations, and short-distance and long-distance allocations, so that the combination of orders is generated, for the orders belonging to the diversified freight allocation type, by a number equal to or less than a maximum number of rotations obtained from user input information,
wherein, when combining the diversified freight allocation, the diversified freight allocation is configured only when a distance between an unloading point for order 1 and a loading point for order 2 is within the empty-vehicle distance for the diversified freight allocation or the unloading point for the order 1 and the loading point for the order 2 are in the same coverage area, and in the case of connected freight allocation, the connected freight allocation is configured as a combination of diversified freight allocations when a distance between an unloading point for the last order on the day D and a loading point for the first order on the day D+1 is within the empty-vehicle distance for the connected freight allocation or the loading and unloading points are in the same coverage area, and
wherein the connected freight allocation combination unit generate possible connected freight allocation combinations using the diversified freight allocation combinations generated by the diversified freight allocation combination unit and a maximum plan period among the user input information as input values, and the connected freight allocation combination is generated by combining the daily diversified freight allocation combinations as many days as between at least two days and no greater than the maximum plan period to satisfy an inter-day empty-vehicle transport distance or coverage area and an order handling sequence.

2. The system of claim 1, wherein the connected freight allocation computation unit:
lists all order IDs belonging to the connected freight allocation combinations that are possible for inter-day connection;
counts the number of times each of the order IDs is included in all of the connected freight allocation combinations to be allocated as a score for each of the order IDs;
sets a sum of the scores allocated to the respective order IDs in each of the connected freight allocation combinations as a score for the respective connected freight allocation combination; and
sorts the respective sums of the scores for the connected freight allocation combinations in ascending order and employs higher-ranked combinations of orders having no order IDs overlapping as final connected freight allocation combination results.
